(19) United States
(12) Patent Application Publication
(10) Pub. No.: US 2021/0228927 A1
(43) Pub. Date: Jul. 29, 2021

(54) Fire Locator Device, Fire Fighting System and Corresponding Operating Method

(71) Applicant: Minimax Viking Research & Development GmbH, Bad Oldesloe (DE)

(72) Inventors: Klaus HOFMANN, Bad Oldesloe (DE); Joachim BÖKE, Bad Oldesloe (DE); Alexander DERKSEN, Bad Oldesloe (DE); Philipp JAUER, Lubeck (DE); Ralf BRUDER, Lubeck (DE)

(21) Appl. No.: 17/153,802

(22) Filed: Jan. 20, 2021

(30) Foreign Application Priority Data
Jan. 24, 2020 (DE) 10 2020 101 687.5

(51) Int. Cl. A62C 37/50; A62C 37/40

(52) U.S. Cl. CPC A62C 37/50; A62C 37/40

(57) ABSTRACT

The present invention relates to a fire locator device (7) and a corresponding fire fighting system (1) comprising at least one housing (2) configured to be mounted at a certain height within or in proximity of an area of operation, in particular at a wall or a ceiling of a room (101) of a building (100), at least one sensor component (5a, 5b, 5c), wherein each sensor component (5a, 5b, 5c) of the at least one sensor component (5a, 5b, 5c) comprises a plurality of sensor elements (50) in a matrix arrangement sensitive at least to radiation, preferably to ultraviolet radiation or thermal radiation, in particular infrared radiation, a self-test component (52) for validating the operability of the at least one sensor component (5a, 5b, 5c), and a controller (9) configured to validate the operability of the at least one sensor component (5a, 5b, 5c) using the self-test component (52) and to receive sensor signals from the at least one sensor component (5a, 5b, 5c) for determining a location of a fire (F) within the area of operation.

The present invention relates to a fire locator device, a fire fighting system and a method for operating the fire fighting system. The present invention applies particularly, without being limited, to the field of residential fire fighting.

A residential sprinkler according to the definition provided in UL 1626 is a sprinkler intended to be installed in residential occupancies and that opens automatically by operation of a heat-responsive releasing mechanism that maintains the discharge orifice closed. Upon operating at a specified temperature, a discharge of water is distributed in a specific pattern and quantity over a designated area. Standards for the installation of sprinklers are defined, for instance, in NFPA 13 R (Residential), NFPA 13 D (Domestic), and EN16925 (Domestic and Residential).

Residential sprinklers are thus actuated by heat and usually discharge fire fighting agent, in particular water, to regions of the protected room far away from the source of the fire, which leads to severe damage caused by water. Currently listed residential sprinklers may cover areas of 20×20 ft (6.1×6.1 m), which means that an even bigger area will be wetted after a sprinkler activation.

A long desire existed therefore to fight fire at specific locations, which correspond to the actual location of the fire or hazard instead of flooding the entire space of protection, for instance the residential room. Expressed differently, the desire existed to fight the fire without collateral damage occurring due to excess discharge to regions, which are not affected by, for instance, the fire. At the same time, the reliability of the system and therefore the safety of operation must not be compromised.

It has therefore been an object of the present invention to provide a fire locator device, a fire fighting system and a corresponding method for operating a fire fighting system, which reduces the risk of collateral damage while maintaining high operational safety and reliability. Further, it has been an object of the present invention to reduce the amount of discharged fire fighting fluid to a minimum.

According to a first aspect, a fire locator device is provided, comprising a) at least one housing configured to be mounted at a certain height within or in proximity of an area of operation, in particular at a wall or a ceiling of a room of a building, b) at least one sensor component, wherein each sensor component of the at least one sensor components comprises a plurality of sensor elements in a matrix arrangement sensitive at least to radiation, c) a self-test component for validating the operability of the at least one sensor component, and d) a controller configured to validate the operability of the at least one sensor component using the self-test component and to receive sensor signals from the plurality of sensor components for determining a location of a fire within the area of operation.

Since the fire locator device comprises a controller, which can both validate the operability of the sensor components and determine a location of a fire within the area of operation, for instance the room, the operational safety and reliability can be maintained, while a fire fighting system can selectively provide, for instance, fire fighting agent to the location of the fire identified by the fire locator device. In other words, it is nearly not possible that a failure of a sensor component of the fire locator device will not be detected for more than the time between two self-tests, which is preferentially adjustable and can be, for instance, 24 hours. This safety-mechanism would avoid that a potential fire is not being detected by the corresponding sensor component, since the self-test component is provided to validate the operability of each of the sensor components, respectively. The self-test component can be configured to validate the operability of all of the sensor components or a plurality of self-test components can be provided for each of the sensor components. Also combinations are feasible.

The radiation to which the sensor elements are sensitive preferably include ultraviolet radiation or thermal radiation, in particular infrared radiation. Where the following embodiments and preferred examples are exemplarily described with reference to infrared radiation, the same benefits and advantages can be achieved when sensors sensitive to other of the preferred ranges of wavelengths of radiation, such as ultraviolet radiation or thermal radiation in general, are employed.

The sensor elements of the sensor components can also be referred to as individual pixels. Further, the sensor elements of one or more sensor components can be referred to as being in an array-like arrangement. Expressed differently, an array of sensor elements can extend over one sensor component or over a plurality of individual sensor components.

In a preferred embodiment, the controller comprises a data storage for storing activity and historic events. Thus, in case of a fire, the cause of events can be reliably reconstructed. For instance, such data can be helpful for fire investigation to identify and track back the source of the fire.

The area of operation is preferably a room of a building, or a part of a room of a building, while in other embodiments also different areas of operation can be protected by the fire locator device. For instance, the fire locator device can also be employed in protecting an area of operation located outside a building, such as a public space or only partly covered structure. It is important that the fire locator device is mounted at a certain height and position, in order to monitor the predefined area of operation in such a way that sources of radiation can be localized within that space, i.e. radiation such as infrared radiation of the fire can be localized within this area of operation.

The fire locator device being mounted within or in proximity of the area of operation is understood as a location of the fire locator device, from which it is possible to observe the area of operation. Expressed differently, the proximity is limited by the capability of the sensor components to effectively monitor the area of operation. In the preferred example of a room, the fire locator device will generally be placed at a certain height of one of the walls which circumscribe the room.

In a preferred embodiment, the self-test component emits infrared radiation and in particular comprises at least one thermal radiation source such as a heating element, the thermal radiation source being arranged in proximity to at least one of the sensor elements, wherein the controller is configured to validate the operability of at least one of the sensor elements of the sensor components by evaluating a sensor signal response to a heating of the at least one heating element.

In a preferred embodiment, the at least one thermal radiation source is located outside a field of view of the at least one sensor component and configured to temporarily heat the at least one sensor component, in particular a housing of the at least one sensor component, such that, in case the sensor component is operable, the sensor signal response of the at least one sensor element to the temporal heating of the thermal radiation source is detectable.

In a different preferred embodiment, the thermal radiation source is located within the field of view of the at least one sensor component. By activating the thermal radiation source, i.e. infrared radiation is emitted by the thermal radiation source, to which the sensor component is sensitive. Thus, by activating the thermal radiation source of the self-test component, a sensor signal corresponding to the signal, which also triggers the sensor component in case of a fire is generated. Thus, it can be determined whether the respective sensor component is operational or not. More specifically, not even only a qualitative but also a quantitative determination of the sensor signal response can be evaluated by comparing an actual sensor signal response to an expected sensor signal response.

In a preferred embodiment, at least one of the thermal radiation sources comprises a resistive heating element. A resistive heating element is a simple and reliable example of a thermal radiation source, which can be heated by providing the resistive heating element with electrical current, for instance. By evaluating the power consumption of the resistive heating element, it is at the same time possible to validate the operability of the thermal radiation source. Thus, a two-layer security means, in which not only the operability of the sensor components but also of the self-test component itself can be validated, is provided.

In a preferred embodiment, the controller is further configured to determine the operability of the at least one sensor component and the intact connection between controller and sensor component by constantly observing a feasibility of the dataflow. In this embodiment, errors in the sensor component as a whole or the link between the sensor component and the controller can be determined in addition to erroneous individual sensor elements.

In a preferred embodiment, the controller is configured to determine the operability of a sensor element of the plurality of sensor elements, in particular of each of the sensor elements, by evaluating a sensor signal response to a direct or indirect effect of radiation from the corresponding thermal radiation source.

In a preferred embodiment, the controller is configured to effectuate a self-test of the sensor components using the self-test component on a recurrent, in particular periodic and most preferably daily, basis.

The probability for an erroneous sensor component to be timely detected can thus be increased. Of course it is also possible to have different and/or varying recurrence intervals.

In a preferred embodiment, the controller is configured to sequentially compare sensor signals from the plurality of sensor elements with a threshold value for determining a location of a fire within the area of operation, wherein the threshold value preferably includes an individual threshold value for each of the sensor elements, respectively.

Each sensor element will output a sensor signal, which is indicative of a magnitude of the incoming radiation, in particular the incoming infrared light. Thus, in case a fire is present at a location, which is “seen” by the respective sensor element, the signal must surpass the defined threshold value. Yet, the threshold has to be chosen sufficiently high, in order to decrease the probability of false alarms. Additionally, a double interlock setup with a fire detection device, in particular a smoke detector, will minimize the probability of false alarms in a preferred embodiment. That means an alarm will preferentially occur only if a sensor threshold is exceeded and the externally or internally connected fire detection device goes off.

Preferentially, each sensor element monitors a specific portion of the area of operation. Thus, there exists a correspondence between a physical portion of the area of operation and the respective sensor element. Based on this correspondence, individual thresholds for each sensor elements can be defined adequately.

In a preferred embodiment, the controller is configured to adjust the sensor signal of at least one sensor element, preferably by providing a threshold value for the signal value of the corresponding sensor element which exceeds the signal value due to hot objects in the area of operation in case a no-hazardous fire is present.

In a preferred embodiment, an individual threshold per sensor element will be used to set an appropriately high threshold to avoid false alarms due to fixed heat sources as e.g. stove, kettle, fireplace or radiators.

In a preferred embodiment, the controller is configured to additionally mask, i.e. deactivate or ignore/block the sensor signal of at least one sensor element. In a preferred embodiment, masking of sensor elements will alternatively or additionally to using individual thresholds be used to avoid false alarms due to fixed heat sources as e.g. stove, kettle, fireplace or radiators.

In a preferred embodiment, the controller is configured to determine malfunctions leading to a stop in operation, such as deadlocks, in the operability of the controller itself using a watchdog timer.

The watchdog timer is a well-known instrument to monitor operability of electronic components. In addition to the monitoring by the self-test component, the fire locator device according to this embodiment incorporates an additional layer of security, which increases overall safety of the operation of the fire locator device according to the invention.

In a preferred embodiment, the fire locator device further comprises at least one temperature sensor, preferably a thermistor, for determining a temperature signal representative of a temperature of the area of operation. For example, the temperature sensor can be located within, outside or in proximity of the housing. In other examples, the temperature sensor is provided together with the fire detection device, e.g. the smoke detector, or at a separate location independent from the location of the fire locator device and the fire detection device.

In this embodiment, the temperature sensor can advantageously be employed to guarantee a double interlock system in case the self-test component determines at least one of the sensor elements and/or sensor components inoperable. In case the temperature sensor indicates an increased temperature, for instance exceeding a predefined threshold, while at the same time, for instance, none of the sensor elements indicates the presence of a fire, the fire locator device can nevertheless realise the unusual situation and, for instance, trigger a fire alarm or the like. In this embodiment, it can be expected that the fire is present at the location of the area of operation corresponding to the inoperable sensor element or sensor component.

The threshold is preferentially selected to correspond to approximately 30K above the temperature expected in the area of operation. In one example, the threshold can be set to a value between 40° C. and 80° C., more preferably to between 55° C. and 75° C. and most preferably to a value between 65° C. and 70° C., such as 68° C. The threshold can also be set with respect to an average temperature measured in the area of operation in the past. For instance, the threshold can be set relative to an average temperature of the last hour, day, week, and the like. In particular, the average can correspond to a moving average, more preferably a weighted moving average. In other examples, the threshold can be predefined and substantially fixed for a particular area of operation.

Further preferentially, the fire fighting is triggered only in case the fire detection device, e.g. the smoke detector, indicates the presence of a fire, such that the double interlock system is ensured. In particular, the fire fighting is preferentially triggered with respect to the zone of the area of operation corresponding to the inoperable sensor element or sensor component. Thus, according to this embodiment, the fire locator device incorporates an additional layer of security, wherein a fire can also be detected and reacted to in case at least one of the other components is inoperable.

In a preferred embodiment, the number of sensor components is three and wherein the array of sensor elements of each sensor components comprises at least 4×4 pixels, in particular at least 8×8 pixels.

It is a finding of the inventors of the present invention that three sensor components comprising, in particular 8×8 pixels, with preferably at least a 60×60 degree field of view is a favourable trade-off between the number of sensor elements and the capability of reliably monitoring an area of operation formed by a standard room, wherein the resolution of the sensor elements is high enough to allow for an accurate positioning of the location of the fire. In other embodiments also sensor components comprising a field of view of at least 180 degrees are contemplated. In such embodiments, provision of a single sensor component can be sufficient to cover an entire area of operation, e.g. a room of a building.

In a preferred embodiment, the sensor components are positioned and oriented in the housing to completely cover a floor of the area of operation extending over 4.27 m×4.27 m, in particular over 5.3 m×4.3 m, when the fire locator device is mounted in a height of between 1.94 m and 2.74 m, in particular between 2.3 m and 2.5 m, wherein the height of the fire locator device is determined as the central position of the plurality of sensor components.

In a preferred embodiment, the controller is configured to determine the location of the fire by mapping at least one of the plurality of sensor elements to at least one zone of the area of operation, preferably to up to two zones out of at least five zones.

The mapping of the sensor elements to zones allows that a corresponding zone, which corresponds to the activated sensor element, is determined as the location of the fire. The correspondence of one sensor element to more than one zone is particularly useful for borders or edges of zones, i.e. regions where two zones border each other.

In a preferred embodiment, the controller is configured to activate a respective one of a plurality of stationary fire fighting devices associated with one of the zones of the area of operation for each of the zones determined as the location of the fire.

In a preferred embodiment, the fire locator device further comprising a power supply, the power supply comprising a mains power supply and optionally a fallback power supply, the fallback power supply preferably comprising a battery. Thus, operational safety can be maintained even in periods in which no mains power is available. The fallback power supply applies in particular for higher risk applications.

In a preferred embodiment, the sensor components are fixedly arranged at defined positions and orientations within the housing, wherein the positions and orientations are defined such that the field of view of the sensor elements of the sensor components is optimized to the geometry of the area of operation.

In a preferred embodiment, all of the sensor components are arranged in a substantially horizontal plane, wherein one of the sensor components is arranged closer to a front of the housing than the other sensor components.

In a preferred embodiment, the orientations of all sensor components are unique.

In a preferred embodiment, a field of view of each sensor component is rectangular, preferentially quadratic.

Preferentially, the field of view of each sensor component spans an opening angle of at least 45 degrees and in particular at least 60 degrees in a vertical and horizontal direction. Thus, the opening angle allows to cover the entire area of operation with a limited number of sensor components. However, the field of view of each sensor component is not limited to a certain minimum opening angle. Alternatively, a larger number of sensor components having smaller opening angles can be employed. A larger number of sensor components reduces the impact of a failure of an individual sensor component, such as the extension of a blind spot resulting therefrom.

In a preferred embodiment, the controller is configured to receive an input signal from an external fire detection device, in particular from a smoke detector.

The input signal from an external fire detection device can thus be used to form a double interlock security system. The double interlock system requires two events to occur before water or other fire fighting agent is released from the system. Thus, only in case the fire detection device, in particular the smoke detector, detects a fire and additionally, for instance, a fire is located by the fire locator according to the invention, fire fighting agent, such as water, is permitted to be released.

In a preferred embodiment, the controller is configured to receive an input signal from one or more internal and/or external temperature sensors, in particular from thermistors. The input signal from the temperature sensor, which is indicative of a temperature of the area of operation, can thus form a double interlock system together with the input signal from the external fire detection device in case at least one of the sensor components and/or the sensor elements is determined to be inoperable. In case an increased temperature is detected, for instance a temperature exceeding a predefined or definable threshold, and the fire detection device indicates the presence of a fire, the fire is determined to exist in a location corresponding to the inoperable sensor elements/sensor components and appropriate action can be taken. Thus, integrity of the system can be guaranteed even in a period until the inoperable components return to be operable, e.g. have been repaired or replaced.

In a preferred embodiment, at least one, preferably all, of the sensor components comprises an infrared sensing array forming the sensor elements.

In a preferred embodiment, the controller comprises a logging component, in particular including a memory, configured to store logging data regarding the fire locator device.

In a preferred embodiment, the controller comprises a network or communication interface, preferably a Wireless Local Area Network or Zigbee interface, to exchange information or store logging data with a centralized server, e.g. a fire alarm central or in a cloud.

In a preferred embodiment at least one of the sensor components comprises a thermopile array having an array of thermophile elements as sensor elements.

A thermopile array is a particularly beneficial selection for the sensor component due to its high reliability and affordable cost. Since the thermopile elements of the thermopile array generate a voltage proportional to the incurring radiation, in particular incurring infrared radiation, a very simple processing of the signal output of the thermopile elements is possible. Thus, overall complexity of the system is kept reasonable.

In a preferred embodiment the thermopile array comprises an array of 8×8 thermopile elements, wherein the number of the plurality of zones is less than the number of thermopile elements, wherein the number of the plurality of zones is in particular four to twenty-five, particularly preferred five including a centrally overlapping zone.

Of course, also higher or lower numbers of thermopile elements and/or zones are contemplated.

Even further, it is contemplated to provide two or more fire locator devices in one single room, wherein the two or more fire locator devices can operate cooperatively on the same area of operation or individually.

In a preferred embodiment the fire locator device comprises at least three thermopile arrays arranged adjacently to each other, each preferentially comprising an array of 8×8 thermopile elements. Thus, a larger angle of view, e.g. to monitor a larger room, can be achieved.

According to a second aspect, a fire fighting system for fighting a fire in an area of operation, in particular in a room of a building, is disclosed. The fire fighting system comprises the fire locator device according to the first aspect or a preferred embodiment thereof, and a plurality of stationary fire fighting devices, each associated with and configured to distribute fire fighting agent within a respective zone of the area of operation, wherein the controller of the fire locator device is configured to a) locate the zone of the area of operation having the fire by identifying those sensor elements of at least one of the sensor components, which sense radiation exceeding a predetermined threshold level, and to b) activate the at least one fire fighting device associated with the located zone.

The fire fighting system according to the invention thus employs the fire locator device according to the present invention to locate a fire in an area of operation, associate the location of the fire with a corresponding zone of the area of operation and then specifically activate the fire fighting device associated with the identified zone. As a result, only the located zone or zones of the plurality of zones of the area of operation is supplied with fire fighting agent, and thus potential damages are limited to the activated zone or zones.

It should be emphasized that the fire fighting system according to the second aspect can advantageously be combined with the preferred embodiments described above with respect to the fire locator device.

In a preferred embodiment, the system further comprises an external fire detection device, in particular a smoke detector, wherein the controller of the fire locator device is configured to activate the at least one fire fighting device associated with the located zone only in case the fire detection device detects a fire.

In a preferred embodiment the system further comprises at least one fire detection device, in particular at least one fire detection device selected from the list consisting of smoke detector, in particular optical beam smoke detector or aspiration smoke detector; flame detector, in particular infrared (IR) flame detector, ultraviolet (UV) flame detector or combined IR/UV flame detector; heat detector; gas detector; or multi-sensor-detector. The controller is configured to control the plurality of fire fighting devices to only provide fire fighting agent to the fire fighting area in case the fire detection device determines the fire.

The fire detection device can thus determine the presence or non-presence of a fire. The fire detection device not necessarily allows for any spatial resolution, i.e. does not need to be able to provide the location of the fire, while it is enough for the fire detection device to detect whether the fire is present or not. Thus, in this embodiment, the detection by the fire detection device presents a requirement for the controller, while the controllable fire fighting devices are only controlled to provide fire fighting agent in case the fire detection device detects the presence of the fire in the room.

In a preferred embodiment, the controller is configured to determine the operability of the sensor elements of the sensor components using the self-test component, and, in case at least one sensor element is determined to be inoperable, to activate the at least one fire fighting device associated with the zone corresponding to the inoperable sensor element in case a temperature signal indicative of a temperature from a temperature sensor, such as from a thermistor, exceeds a predefined threshold.

Advantageously, also in this situation, in which at least one sensor element is determined to be inoperable, the desired double interlock system can be maintained by relying on the signal of the temperature sensor and the fire detection device. Expressed differently, a reliable activation can be ensured even in case one or more of the sensor elements are inoperable. In this case, i.e. in case at least one sensor element is inoperable, the temperature signal can be considered a verification for the fire detection device, in particular the smoke detector, indicating presence of a fire. The location and zone of the fire is deemed to be the location corresponding to the inoperable sensor element. It should be noted that the same principle can be maintained by using any arbitrary combination of at least two independent fire detection devices.

Preferentially, the fire detection device and the sensor components both positively verify the presence of a fire, before a fire signal is triggered and the activation of a fire fighting device is triggered. In case at least one sensor component is inoperable, the temperature signal can replace the sensor components for verification of the fire detection signal by the fire detection device. In one example, in case it is possible to determine which of the sensor elements is inoperable, the activation of the zone corresponding to the inoperable sensor elements is initiated. Alternatively, or in case no location of the inoperative sensor element can be determined, all available zones associated exclusively with the inoperable sensor component can be activated.

Preferentially, by considering zones associated exclusively with the inoperable sensor component and not with any of the further sensor components. To this end, preferentially a redundancy is created by having overlapping coverage of zones by the different sensor components, such that it is particularly preferentially sufficient to activate at most two zones at the same time. Thus, a sufficient flow rate of fire fighting agent to the concurrently activated zones can be ensured.

Further, in case the fire detection device is inoperable, the temperature sensor can replace the fire detection device and act as a double interlock device for verifying the presence of a fire detected by at least one of the operable sensor components. In this configuration, a high reliability of the entire system is ensured, without requiring additional components for redundancy and the like. However, at the same time, in case at least one of the components of the system fails, it is preferred for a signal to be triggered, which indicates the requirement of maintenance as soon as possible.

In a preferred embodiment the controller is configured to associate each of the sensor elements of the sensor components to at least one of the zones so that at least two zones overlap. Since at least two zones overlap, a risk of insufficient coverage, particularly at the edges between two zones, can be reduced. Further, inaccuracies related to the definition of the zones have less impact.

In a preferred embodiment at least two adjacent zones out of the plurality of zones partially overlap at their edges, respectively.

Preferentially, in case adjacent zones overlap at their edges, a fire being determined in the overlapping portion of the adjacent zones can result in both of the adjacent zones being designated as the fire fighting area. It can thus be avoided that a fire being present at or near by an edge be insufficiently extinguished by activating both of the adjacent zones.

Further, even in case one of the stationary fire fighting devices does not have a completely uniform discharge pattern of fire fighting agent, e.g. a fluid flow is less near the edge of the zone covered by the respective fire fighting devices, as a sufficient fluid flow of fire fighting agent even for fires occurring at or near an edge of the respective zones can be guaranteed.

In a preferred embodiment at least one zone of the plurality of zones entirely overlaps one or more of the other zones of the plurality of zones. The zone entirely overlapping one or more of the other zones can be regarded a redundant zone, which is advantageous to activate in case the fire is detected far away from the centers of those zones, which are overlapped by the overlapping zone. It is thus not necessary to provide fighting agent to areas far away from the detected fire by adding the overlapping zone to the fire fighting area. Accordingly, a risk of damage due to excess fire fighting agent can be reduced.

In a preferred embodiment the floor of the zone is distributed among four adjacent zones of the plurality of zones. A fifth zone of the plurality of zones is located in a central area of the room, overlapping a portion of each of the first to fourth zone of the plurality of zones. In a further preferred embodiment, also at least part of the wall surface is additionally distributed among the zones.

In a preferred embodiment a surface area of each of the plurality of zones is approximately equal. Thus, assuming that a fluid flow through each of the stationary fire fighting devices covering the fire fighting area is approximately equal, also the fluid flow to each portion of the respective zones is approximately equal. Thus, a homogeneous fluid supply to each portion of the area of operation can be assured.

Preferentially, the surface area comprises a floor and a wall surface area. In some embodiments, the floor area can be given a higher weight, i.e. the calculation of the total area to be provided with fire fighting agent of each zone can be biased towards the floor area. Thus, for example, a need for more fluid flow to the floor surface as compared to the wall surface per surface area can be implemented.

In a preferred embodiment the grid of sensor elements of at least one of the sensor components defines a pixel matrix. The controller is configured to determine a transformation between the pixel matrix and the plurality of zones.

The transformation, which could also be referred to as a mapping between pixel matrix and plurality of zones, thus ascertains a correspondence between pixels of the pixel matrix defined by the sensor elements of the sensor components and the zones of the area of operation. The transformation can be determined by the controller using input from the user and/or relying on a predefined configuration. The predefined configuration can take, for instance, geometrical details of the area of operation, e.g. the covered room, into consideration.

In a preferred embodiment the controller is configured to determine the transformation under consideration of at least one of a spatial angular resolution of the sensor elements of the array sensor, a field of view of the array sensor and a location of the array sensor in the room. Thus, also a distance, angle and other distortion, which effect the field of view of the array sensor with respect to the room are considered.

According to a third aspect, a method of operating a fire locator device according to the first aspect or a fire fighting system according to the second aspect or a preferred embodiment thereof is disclosed. The method comprises a) validating an operability of the sensor elements of the sensor components by means of the self-testing component, b) determining a fire detection signal indicative of a fire, in particular from a fire detection device, preferably from a smoke detector, c) determining a sensor signal for each sensor element of the sensor components, and, d) determining an operation mode of the fire fighting device in response to the fire detection signal, the operability of the sensor elements and the sensor signals.

Preferentially, the method includes constantly validating the connection and operability of the sensor components, the connection to fire detection device, e.g. the smoke detector, and/or the operability of the temperature sensor, e.g. the thermistor.

The method achieves the same advantages as the fire locator device or the fire fighting system described above and can be advantageously adopted to and combined with any of the preferred embodiments described with reference to the fire fighting device above.

In a preferred embodiment, the method further comprises e) determining a temperature within the area of operation, in particular from at least one temperature sensor, preferably from a thermistor, wherein the operation mode of the fire fighting device is additionally determined in response to the temperature. In this embodiment, as described before, operability of the fire locator device or system can be maintained even in case a sensor component/sensor element or the external fire detection device is inoperative or erroneous.

In a preferred embodiment, a normal operation mode is determined in case the sensor elements are determined to be operable and at least one of the following conditions are fulfilled: the fire detection signal indicates no fire, and/or no sensor signal exceeds a predefined threshold, wherein the predefined threshold is preferentially predefined individually for each sensor element, respectively.

In a preferred embodiment, the fire locator device is configured to selectively activate at least one out of a plurality of stationary fire fighting devices in a normal activation mode, each of the stationary fire fighting devices associated with and configured to distribute fire fighting agent within a respective zone of the area of operation, wherein the controller locates the zone of the area of operation having the fire by identifying at least one hot spot formed by at least one sensor signal exceeding a predetermined threshold level.

In a preferred embodiment, a normal activation mode is determined as the operating mode in which the at least one fire fighting device associated with the located zone is activated in case all sensor elements are determined to be operable, at least one sensor signal exceeds a predefined threshold, wherein the predefined threshold is preferentially predefined individually for each sensor element, respectively, and the fire detection signal indicates the presence of a fire.

In a preferred embodiment, a maintenance warning mode is determined as the operation mode in case at least one of the sensor components or sensor elements is determined to be inoperable and/or a connection error is determined, the fire detection device or the temperature sensor is determined to be inoperable and/or a connection error is determined, and/or a malfunction leading to a stop in operation, such as a dead lock in the operability of the controller, is determined using a watchdog timer.

In a preferred embodiment, a first failure valve opening mode is determined as the operation mode in case at least one sensor element is determined to be inoperable, the fire detection signal indicates the presence of a fire and the temperature signal exceeds a predefined threshold. In the first valve opening mode, the fire fighting device is preferentially configured to selectively activate the stationary fire fighting device or devices corresponding to the zone or zones associated with the inoperable sensor element or elements.

In principle, it is thus required for the fire detection signal to indicate a fire and to further have at least one of the sensor signals exceeding a predefined threshold or the temperature within the housing exceeding a predefined threshold. Thus, in all cases, a double interlock system is guaranteed.

Further, in case of the first failure valve opening mode, the temperature signal is the second triggering activation signal in addition to the fire detection signal and thus replaces the sensor signal of the inoperable sensor elements or sensor components, which thus does not exceed a predefined threshold. However, the inoperable sensor elements can be allocated to respective zones, which allows for determining the zone or zones in which a fire can be present, i.e. a selective activation restricted to zones which are expected to have a fire is possible also in the first failure valve opening mode.

In the alternative, preferentially an activation can be carried out independent from the mode of activation and the association to respective zones in the first failure valve opening mode.

In a preferred embodiment, a second failure valve opening mode is determined as the operation mode in case the fire detection signal indicates no presence of a fire, the temperature signal exceeds a predefined threshold, and at least one of the sensor signals exceeds a predefined threshold, respectively. In the second failure valve opening mode, it is assumed that the fire detection signal is incorrect, for instance due to an inoperative fire detection device or a compromised connection between the fire detection device and the fire fighting device. Activation of one or more of the stationary fire fighting devices is then performed as in the normal activation mode.

Hereinafter, preferred embodiments of the invention will be described with reference to the accompanying drawings in greater detail.

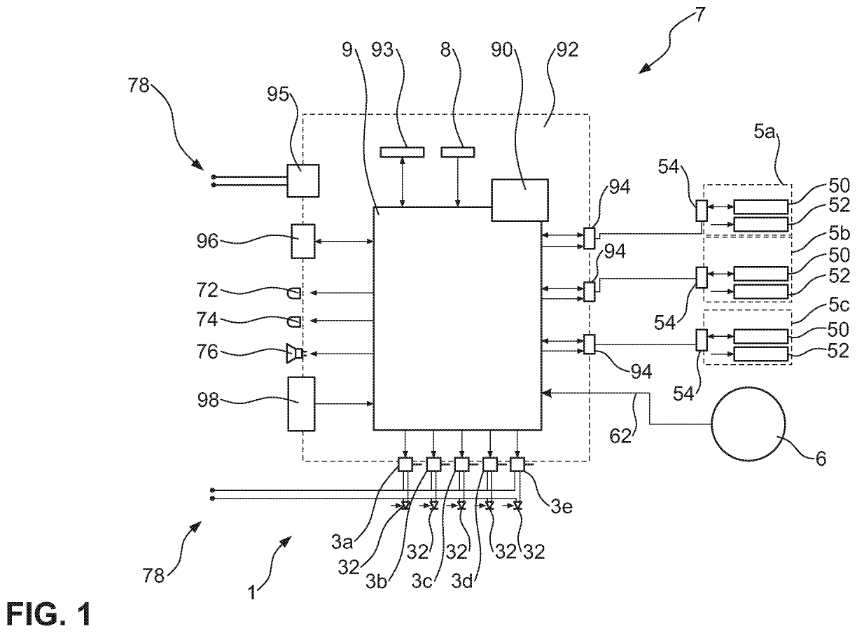

FIG. 1 shows a schematic block diagram of a fire locator device,

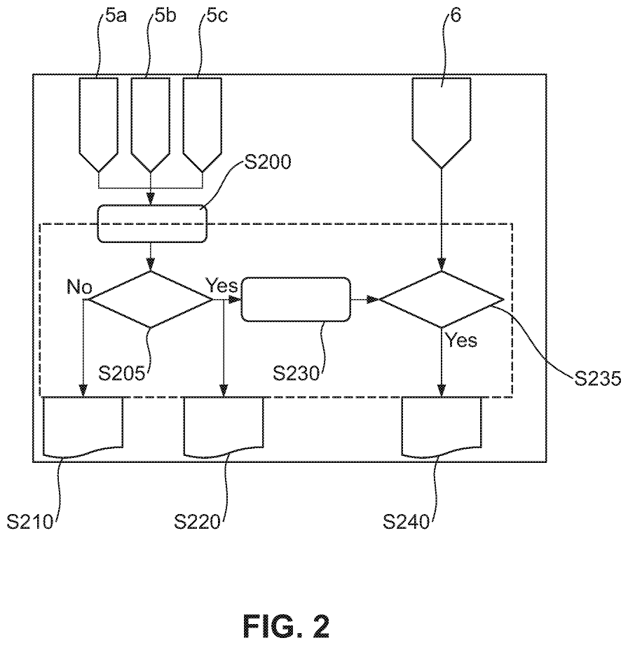

FIG. 2 a schematic flowchart of an operation of the fire locator device shown in FIG. 1,

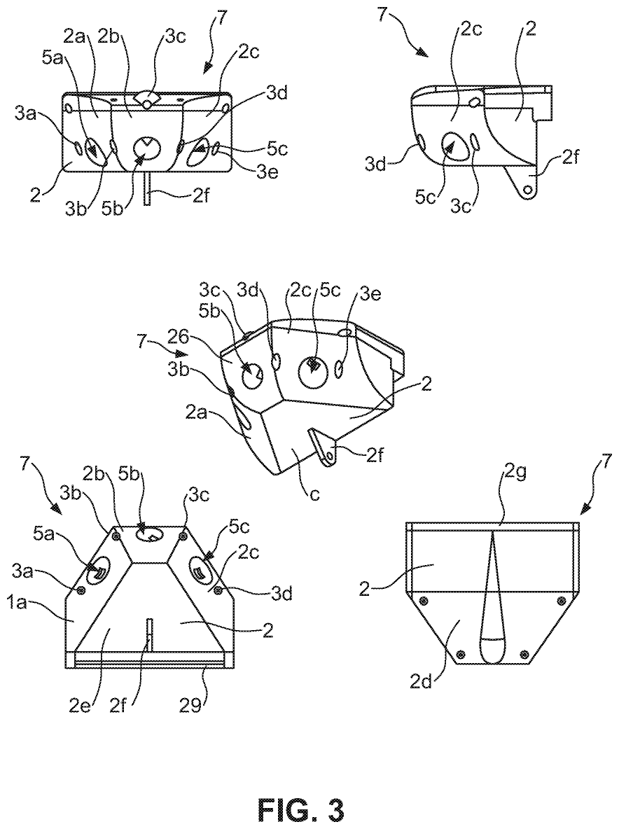

FIG. 3 perspective views of a housing of an embodiment of the fire locator device,

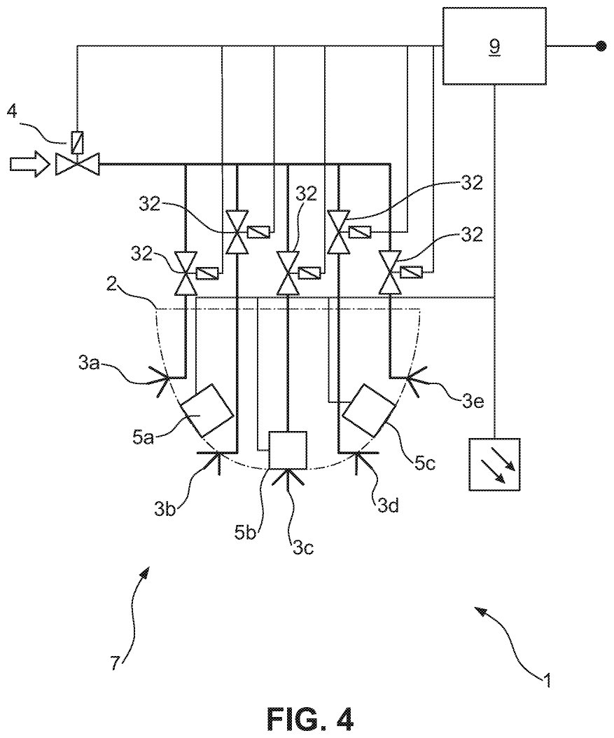

FIG. 4 a schematic view of hydraulics of the fire locator device,

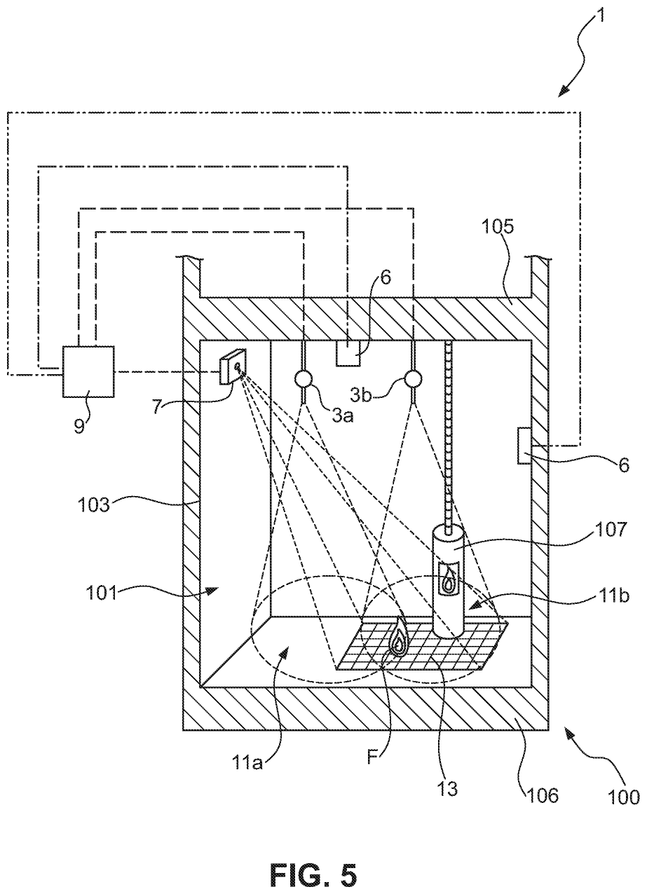

FIG. 5 a schematic view of a fire fighting system,

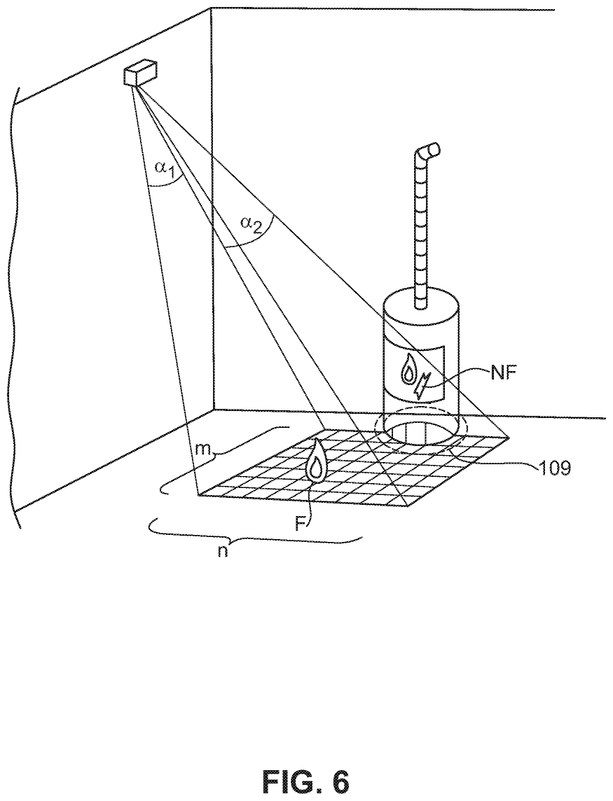

FIG. 6 a schematic detail view of the system according to FIG. 5,

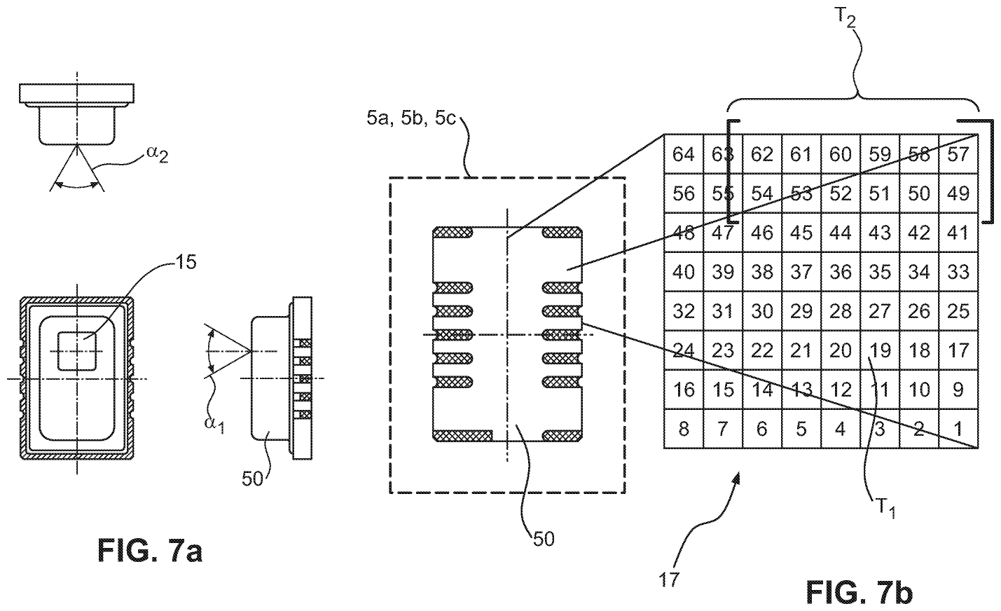

FIG. 7 a, b a schematic detail view of an array sensor used in the system of FIGS. 5 and 6,

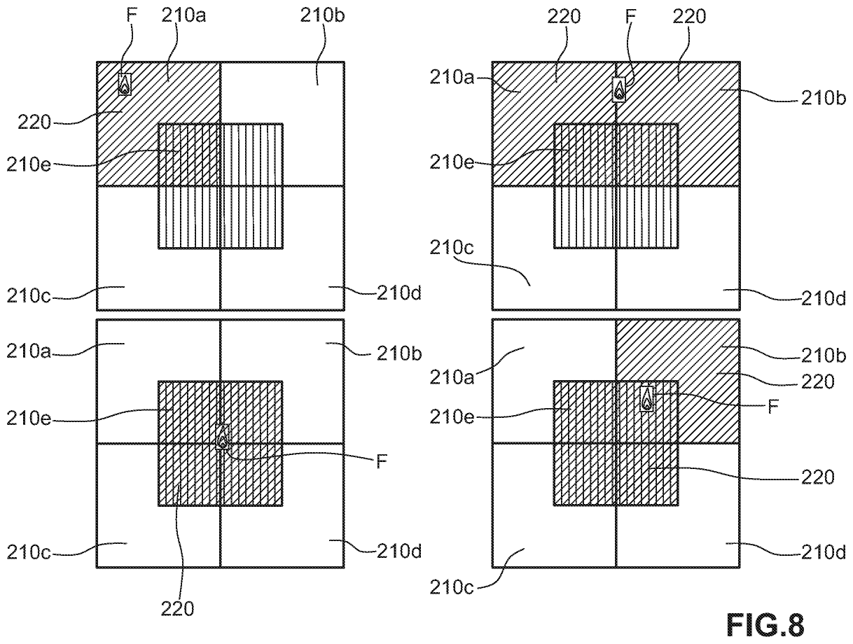

FIG. 8 a schematic view of a first example of zones in a room,

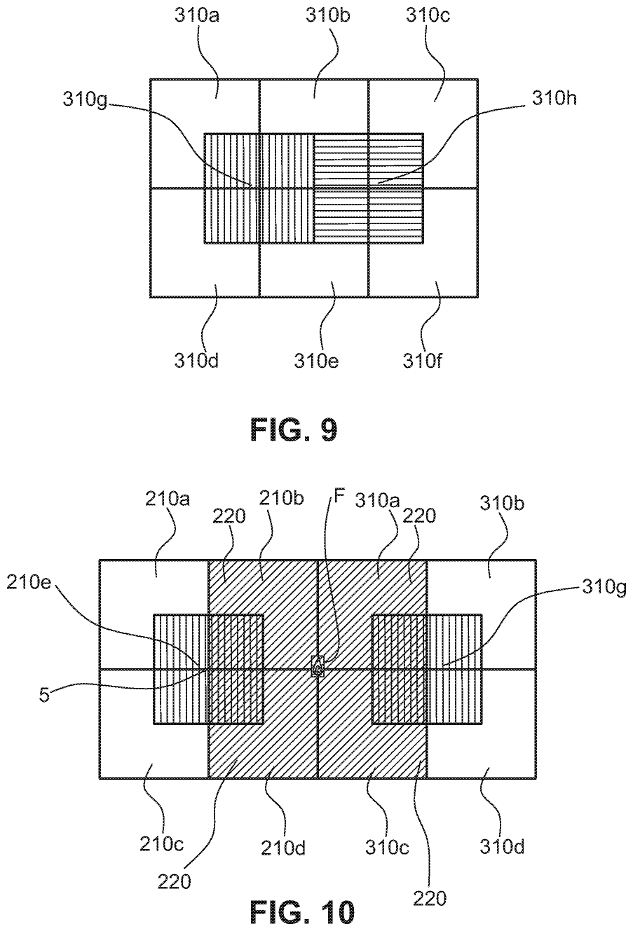

FIG. 9 a schematic view of a second example of zones in a room,

FIG. 10 a schematic view of a third example of zones in a room,

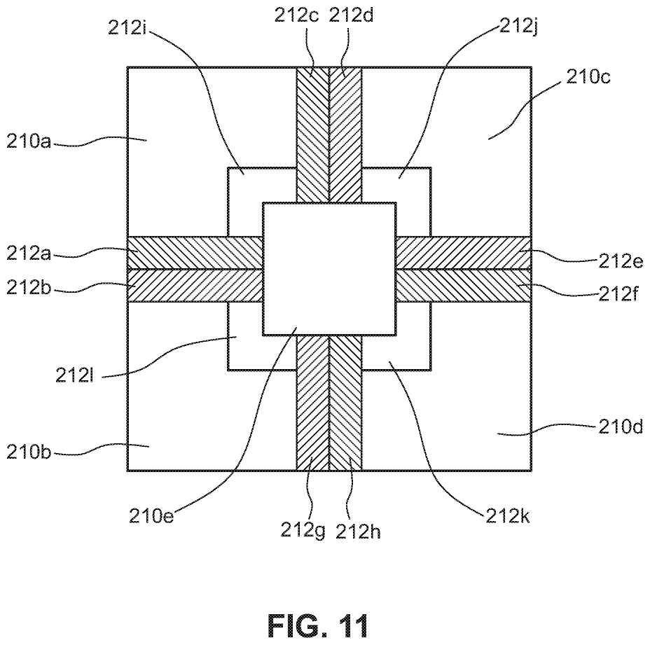

FIG. 11 a schematic view of a fourth example of zones in a room,

FIG. 12 a perspective view of an embodiment of a fire locator device,

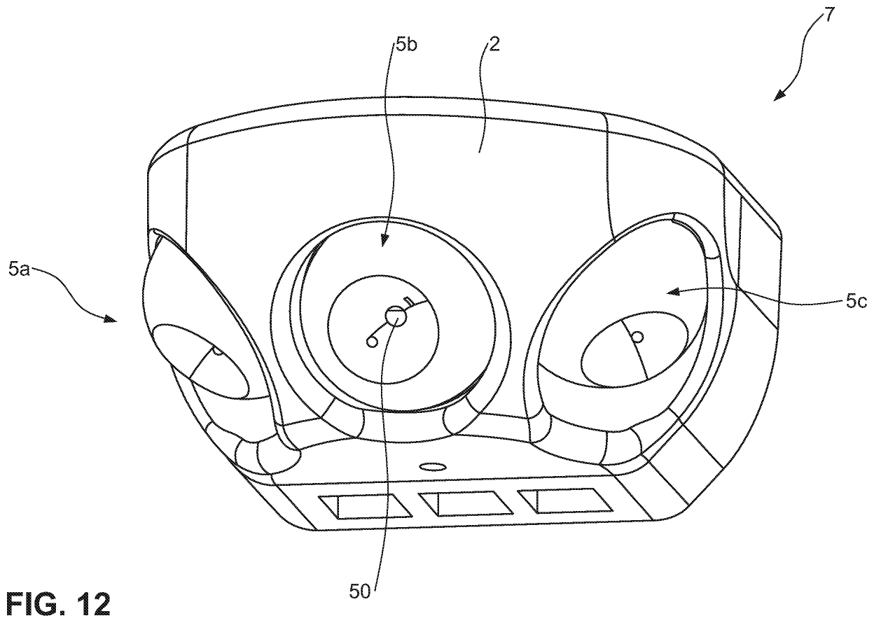

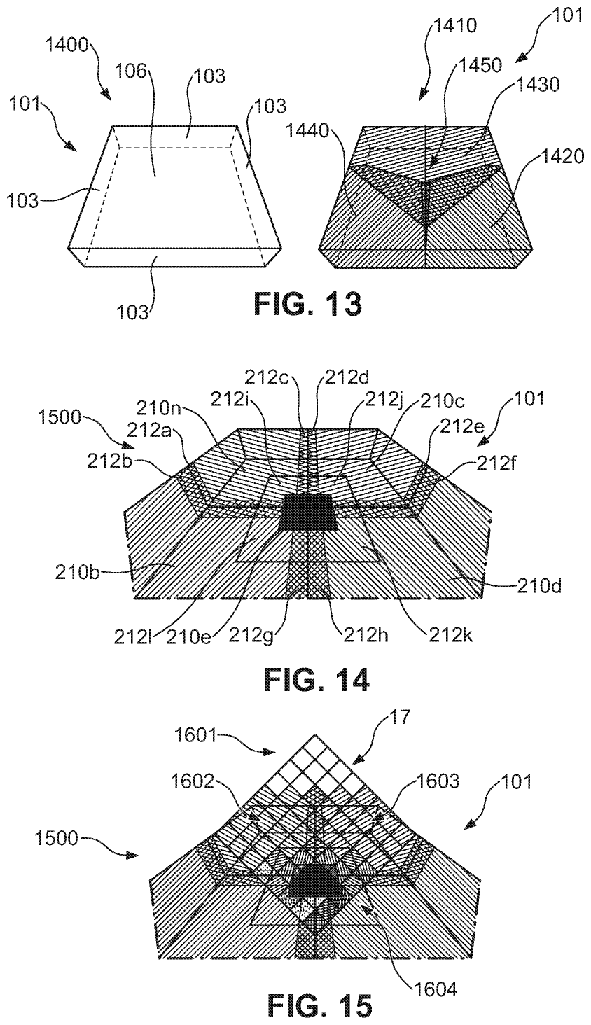

FIG. 13 perspective views of a room,

FIG. 14 a perspective view of zones in a room, and

FIG. 15 a mapping between zones and the pixel grid.

FIG. 1 schematically and exemplarily illustrates a layout of a fire locator device 7 of a fire fighting system 1 according to the present invention. The fire locator device 7 comprises a controller which is arranged to communicate with a plurality of further components of the fire locator device 7. Internally, fire locator device 7 comprises a watchdog timer 90 which validates the operability of controller 9, a memory 93, which is configured to store inter alia documentation and other computer instructions intended to be executed by controller 9 on a mainboard 92. Mainboard 92 further comprises at least one, in this example three, interfaces 94, which are configured to communicate with one of respective sensor components 5a, 5b and 5c.

Mainboard 92 further comprises a power interface 95, which is configured to be connected to a power supply 78, such as a mains connection. Further, a serial interface 96, such as an USB interface, designed to communicate with, for instance, a computer, is provided. Finally, a maintenance button 98 is provided, with which a maintenance mode can be activated, for instance.

Fire locator device 7 is further adapted to indicate its status using a status indicator 72, a maintenance indicator 74 and an acoustical indicator 76, for instance. The status indicator 72 and the maintenance indicator 74 can also be arranged in the same indicator, such as a single RGB-LED. Also other implementations are of course feasible. Acoustical indicator 76 can, for instance, indicate acoustically in case a fire is located by fire locator device 7.

Fire locator device 7 is configured to communicate with a fire detection device 6, such as a smoke detector, which is provided external to fire locator device 7. Most importantly, fire locator device 7 in general is only configured to activate one or more out of fire fighting devices 3a, 3b, 3c, 3d and/or 3e in case fire detection device 6 confirms the presence of a fire, for instance detects smoke. In one example, each of fire fighting devices 3a, 3b, 3c, 3d and/or 3e comprises a relais or different interface, which is configured to communicate with controller 9. Fire detection device 6 is communicating with controller 9 by means of a connection 62, which can be provided as a wire or wirelessly.

Each of the sensor components 5a, 5b and 5c comprises an array sensor 50 having a plurality of thermopile elements as sensor elements, a heating element 52 and an interface 54. Heating element 52 is part of self-test component and is configured to heat array sensor 50 in order to evaluate the sensor signal in response to the heating. In case at least one of the sensor elements of array sensor 50 is inoperable, a deviation of the expected signal response can be detected. Thus, it can reliably be detected that each of sensor component 5a, 5b, 5c is operating normally. The triggering of the self-testing of sensor component 5a, 5b and 5c is preferentially conducted or initiated by controller 9, while it can also automatically be initiated by a dedicated circuitry provided with each of sensor components 5a, 5b and 5c.

Preferentially, heating element 52 is provided at a suitable position touching the sensors case to optimally heat up the sensor component. In other examples, the heating element 52 is provided at a suitable position in front of array sensor 50 or a transition component is provided, which is capable of moving heating element 52 to its operating position in front of or in proximity of array sensor 50 in case the self-testing is performed. In either case it is advantages that heating element 52 does not obstruct portions of the feel of view of array sensor 50, which could lead to less accurate localization results. Interface 54 is configured to provide the sensor signals originating from array sensor 50 to controller 9 and can further be configured to communicate or initiate signals relating to operation of heating element 52, i.e. to the self-testing functionality.

In case at least one of the sensor elements of array sensor 50 indicates the presence of a fire, i.e. provides a signal value exceeding a predefined threshold, and, at the same time, fire detection device 6 indicates the presence of a fire, controller 9 is configured to open at least one of valve 32 connected to at least one of fire fighting devices 3a, 3b, 3c, 3d and/or 3e. Fire fighting devices 3a to 3e are not part of fire locator device 7 but are comprised in a system 1 for fire fighting, which will also be described with respect to the further figures. Expressed differently, the fire fighting devices 3a, 3b, 3c, 3d and 3e can be provided separate and distant from fire locator device 7, while it is of sole importance that controller 9 is capable of activating the respective fire fighting device 3a to 3e, if required.

FIG. 1 further illustrates a thermistor 8, which is configured to determine a temperature within the area of operation. Thermistor 8 can be integrally formed with fire locator device 7 and provide an internal temperature thereof. Additionally, or alternatively, it can be arranged outside a housing of fire locator device 7 and provide an external temperature thereof. Further additionally or alternatively, thermistor 8 can be located remote from the further components of fire locator device 7, for instance at another location within the area of operation. In summary, thermistor 8 is configured to determine a temperature within the area of operation, which can be employed to further increase the reliability of the system. As further described below, the provision of thermistor 8 can ensure a double interlock system even in case one of the further components of system 1 fails.

In order to determine which of fire fighting devices 3a to 3e is to be activated by controller 9, a mapping between sensor elements of array sensors 50 and zones of the area of operation, which is monitored by fire locator device 7 is determined or provided. Further, each of fire fighting devices 3a to 3e is associated with one of these zones, respectively. An example of the determination of zones and the association with respective sensor elements will be described below with reference to, for instance, FIGS. 7 to 11 and 13 to 15.

FIG. 2 schematically and exemplarily illustrates a flow chart of an operation of the fire locator device 7 shown in FIG. 1. In this exemplary flow chart, it is expected that all sensor components 5a, 5b and 5c operate normally and without error. In a step S200, signals of sensor components 5a, 5b and 5c are subjected to a step called pixel masking. Pixel masking compares each individual signal value of each sensor element of the array sensors 50 of the respective sensor components 5a, 5b, 5c with an individual signal value threshold. The threshold may be the same for all sensor elements, but can also be individually assigned or adapted to the respective location, which is observed by the respective sensor element. For instance, at the location the respective sensor element monitors a higher than usual temperature is expected, the threshold value will be set to a higher value, such that the standard temperature expected at the respective location does not trigger the fire alarm signal. For reasons it is also possible not only to increase or decrease the thresholds, but also to completely ignore the sensor element, which is referred to as masking. One of these examples can be, for instance, a kitchen having a cooking hob, an oven or even a candle. After having subjected the signal values to step S200, i.e. to pixel masking, in a step S205 is evaluated whether the pixel values exceed the corresponding threshold. In the negative, i.e. in case sensor elements have signals lower than their respective threshold, the operating status is set to normal, i.e. a step S210. To the contrary, in case at least one of the sensor elements exceeds the respective threshold, a status is set to alarm in step S220 and a mapping is conducted between the pixel, i.e. the sensor element, to the spatial position within the area of operation observed in a step S230. The mapping is performed in order to determine which of fire fighting devices 3a to 3e is to be activated in response.

Then, in a step S235, the double interlock is performed, in other words, it is determined whether the signal is a true fire. To this end, an output of fire detection device 6 is additionally considered. Only in case fire detection device 6 additionally indicates the present of a fire, step S240 is executed, leading to an activation of at least one of the fire fighting devices 3a to 3e. Thus, the fire fighting is initiated.

FIG. 3 schematically and exemplarily illustrates perspective views of a housing 2 of fire locator device 7 as described above. Housing 2 comprises side surfaces 2a, 2b, 2c, at top surface 2d, a bottom surface 2e and a mounting extension 2f and rear surface 2g. At the front end side surfaces 2a, 2b, 2c openings for respective sensor components 5a, 5b, 5c and fire fighting devices 3a to 3e can be seen. While in this example one housing 2 comprises openings for also the fire fighting devices, it is contemplated that the fire fighting devices can be provided at a different housing separate from housing 2. The arrangement of in particular the side surfaces 2a, 2b, 2c allows for the sensor components 5a, 5b, 5c to observe or monitor a large area of operation when housing 2 is mounted at a wall or sealing of a monitoring space, such as a room of a building.

FIG. 4 schematically and exemplarily illustrates a control structure and hydraulics, such as pipes and valves, of a fire locator device 7 of fire fighting system 1. It can be seen that a fire fighting agent valve 4 is provided, which connects fire fighting agent, for instance coming from a piping installation, with valves 32 of each of the respective fire fighting devices 3a to 3f. The three sensor components 5a, 5b, 5c are arranged substantially among the fire fighting devices 3a to 3e such that a broad angle of view can be monitored. In particular, the distribution of fire fighting devices 3a to 3e and sensor components 5a to 5c is such that coverage of the space or room to be monitored is optimized. It can be seen that both fire fighting agent valve 4 and valves 32 of each of the respective fire fighting devices 3a to 3e are in communicating connection with processor or controller 9, which activate each of the respective valves in case both the fire detection device 6 and at least one of sensor components 5a to 5c indicates presence of a fire. As further described in detail below, the double interlock activation can additionally or alternatively be employed using a temperature detected by thermistor 8.

FIG. 5 shows a fire fighting system 1. The fire fighting system 1 is installed in a room 101 of a building 100. The room comprises a number of side walls 103, a ceiling 105 and a floor 106. Inside the room 101, a heat source 107 is installed. The room 101 is an example for an area of operation protected by the fire fighting device.

It should be noted that, while an entire room 101 is illustrated in FIG. 5 and some of the consecutive figures, the system according to the invention can also be provided to protect only a part of the room. In this case, also a plurality of systems 1 according to the invention can be provided to protect the entire room. Thus, a room according to this invention is used as a defined area of operation under protection by fire fighting system 1, which can also be a part of a physical room, i.e. a construction being enclosed by walls and ceiling.

The system 1 comprises a number of fire fighting devices 3a, b which are installed for example under the ceiling 105 of the room 101, but could alternatively also be wall-mounted. The fire fighting devices 3a, b may for example be open fire fighting nozzles of a deluge system.

The system 1 further comprises a plurality of fire detection devices 6 installed in the room 101, for example under the ceiling 105 and/or on one of the side walls 103. While a plurality of fire detection devices 6 is illustrated in FIG. 5, it should be noted that also a single fire detection device is sufficient in other examples.

The system 1 further comprises a fire locator device 7 that is configured to locate a fire F in the room 101. The fire detector devices 6 are configured to detect the presence of a fire in the room 101. The fire fighting devices 3a, b are each positioned such that they distribute fire fighting agent within a respective coverage zone 11 a, b (hereinafter also “zone”) of the room 101. The zones 11a, b may overlap.

System 1 further comprises a controller 9 which is in signal communication with the fire fighting devices 3a, b with the fire detection devices 6 and with the fire locator device 7. The controller 9 is configured to activate the fire fighting devices 3a, b in reaction to a detection of the fire F as is detailed further herein below.

Each of the sensor components 5a, 5b, 5c of the fire locator device 7, which was described in detail with reference to FIG. 4, comprises an array sensor 50 (FIGS. 7a, b) which has a defined field of view having a first view angle α1 and a second view angle α2 (FIG. 6). Within its field of view, the array sensor 50 is adapted to monitor a predetermined area, or zone, of the area of operation, e.g. of room 101. The array sensor 50 comprises a sensor array 15 having a plurality of n×m pixels arranged in a grid 17. Since the fire locator device 7 is stationary, i.e. fixedly installed in the room 101, once oriented, each of the pixels of the grid 17 is specifically assigned to a specific portion of the room 101. Depending on the distance of the fire locator device 7 from e.g. the floor 106 of the room 101 and depending on the specific view angles α1, α2, the grid 17 of pixels defines a projection 13 of the pixel grid 17 in the room 101. A fire F which lies within this projection 13 will be determined by the grid 17 of the sensor array 15.

Preferably, the sensor array 15 is an infrared sensor array, in particular a thermopile array. The array sensor 50 is configured to generate for each pixel a signal representative for a temperature within the portion of the projection 13 in the room 101. The fire F will cause representative temperature signals to be generated by the array sensor 50. The controller 9 is configured to receive the representative temperature signals from the array sensor 50. Also, the controller 9 is configured to allocate specific threshold values T₁, T₂ to each pixel of the sensor array 15. There may be two or more different threshold values used across the array. According to the invention, it is possible to designate a threshold value that will be reached only in case of a fire, or not be reached at all, the latter being especially useful to permanently “blind” the array sensor from certain stationary hotspots that are indicative of non-hazardous fire related heat sources. More specifically, it is even possible to “blind” individual pixels of the sensor array 15 and thus keep the area, which is “excluded” to a minimum area around the stationary hot spots.

However, each threshold value may also be indicative of a temperature limit, the breach of which happens only in case of a fire in that specific portion of the room. As soon as the temperature in the pixels of the sensor array 15 exceeds the predetermined threshold levels T₁, T₂ indicative of a fire, the controller not only has identified the presence of a fire F in the room 101, but additionally has located the portion within the projection 13 (FIG. 5) where the fire F resides by identifying the respective hot spot among the grid 17 (FIG. 7b) of pixels. This allows for very efficient allocation of the fire fighting device 3a or 3b that is ideally positioned to distribute fire fighting agent in the zone where the fire F has been located.

Depending on whether the fire has been located in a zone that is overlapped by the zones 11a, b covered by a plurality of fire fighting devices 3a, b, the controller 9 may also activate more than one fire fighting device 3a, b, but ideally no more than two fire fighting devices 3a, b.

In many rooms, in particular residential rooms, it is to be expected that stationary heat sources such as heat source 107 are present in a portion monitored by the fire locator device 7. In order to prevent false fire alarms, and in order to prevent inaccurate location of actual fires due to the influence of stationary heat sources, the controller 9 is configured to assign specific threshold values T₂ to all pixels which are within range of the stationary hot spot 109 formed by the stationary heat source 107. As is depicted in FIG. 6 and FIG. 7b, the controller 9 could for example be programmed to assign a higher threshold value T₂ to pixels 49 through 54 and 57 through 62, while assigning a lower threshold value T₁ to the remaining pixels of the grid 17. By doing so, increased temperatures emanating from heat source 107 would not be flagged as hotspots indicative of a fire F, unless the predetermined higher threshold value T₂ is exceeded.

This allows the controller 9 to distinguish between a fire F and a fire-unrelated or non-hazardous-fire heat source NF. Basically, any number of stationary heat sources may be accounted for in this way.

While the embodiments of FIG. 5 through 7b show a simple set-up of a room 101 having only one fire locator device, the invention also covers embodiments wherein the room 101, either due to its size or due to its complexity of its layout, requires the use of more than one fire locator device. Preferably, the entire floor 106 of the room is covered by grids 17 of pixels emanating from specifically mounted and oriented fire locator devices 7. Depending on economic factors and ease of installation, the number of fire locator devices for the size of the grid 17 of pixels for each fire locator device 7 may be modified according to need. At any rate, the invention allows for the use of array sensors 50 having sensor arrays 15 with comparatively low resolution (in particular when compared to prior art systems using high-resolution infrared camera systems).

FIGS. 8 to 11 schematically and exemplarily illustrate different configurations or distributions of zones 210a-210e or 310a-310h in different rooms, respectively.

FIG. 8 illustrates a layout of four zones 210a-210d, which are equal in size and apportion the surface area of the room among them. In other words, the four zones 210a-210d cover the entire surface area, i.e. the floor and—if necessary—at least part of the wall surface area of the room. A further, fifth zone 210e is located in the center of the room and overlays all of the other four zones in the center of the room. Fifth zone 210e is thus redundant and provided to limit the spacial extension and also the amount of the fire fighting agent dispersion.

In FIG. 8, four examples of a fire F at different locations within the illustrated room, i.e. within different zones 210a-210e, are illustrated. Each of the examples of the fire F leads to the determination of a fire fighting area 220 by the controller 9, which is as follows. In the first example, since the fire F is located within zone 210a, the fire fighting area is determined to be comprised of zone 210a. In the second example, the fire F is located at the edge between zone 210a and zone 210b, such that both zone 210a and zone 210b are determined as the fire fighting area 220. The third example shows the fire F in the center of the room. In this example, only zone 210e is determined as fire fighting area 220. In the last example, the fire F is located close to the center within zone 210b. Thus, both the central zone 210e and zone 210b are determined as fire fighting area 220. In these examples, for the reasons discussed above, it is preferred that not more than two zones 210a-210e be determined as fire fighting area 220.

In this example, both the room and each of the respective zones 210a-210e are of quadratic shape for the ease of illustration, while of course also different examples of shapes are contemplated. The quadratic shape is particularly beneficial in combination with specific controllable nozzles as fire fighting devices, e.g. fire fighting device 3a-3e, such as a Viking Model A full cone nozzle or a similarly operating, publically available nozzle.

FIG. 9 substantially corresponds to the example of FIG. 8, wherein the room as an example of an area of operation—or likewise a part of the room—is rectangular and its surface is distributed among six zones 310a-310f, which are also in this example quadratic and of equal size. Two central zones 310g and 310h are respectively provided to overlap four adjacent of the zones 310a-310f, respectively. The determination of a fire fighting area 220 is performed analogous to the example of FIG. 9. In other word, not more than two zones 310a-310h are determined to be part of the fire fighting area (not shown in FIG. 5) at the time.

FIG. 10 schematically illustrates a further example, wherein the room is split into two substantially independent regions of five zones 210a-210e, 310a-310d and 310g, respectively. For examples, each of the two groups of five zones can be coordinated and controlled by a particular, individual controller 9 and/or fire locator device 7. In other examples, the two groups can also be controlled commonly by a single controller 9 and/or fire locator device 7.

In the example of FIG. 10, the two fully overlapping regions 210e, 310g are not adjacent to each other, different from the example of FIG. 9, in which two completely overlapping zones 310g, 310h are adjacent to each other. In the example of FIG. 10 a fire F is illustrated in the center of the room. In this example, the fire fighting area 220 is extended to include two zones 210b, 210d, and 310a, 310c of each of the first and second group of zones 210, 310, respectively.

Accordingly, in this example also the situation, in which more than two zones are comprised in the fire fighting area 220 is illustrated. The example of FIG. 10 is particularly useful in case two substantially independent systems for fire fighting are arranged in the same room. In this case, two zones per independent system are comprised in the fire fighting area 220, respectively. Then, again, not more than two zones will be activated concurrently, i.e. designated as the fire fighting area 220

It is of course contemplated that also in the example of FIG. 10 a further fully overlapping zone can be defined in between the zones 210e and 310g. In this particular case, it would be beneficial to protect the entire room as illustrated in FIG. 10 with a single system for fire fighting according to the invention.

FIG. 11 schematically and exemplarily illustrates the effect of overlapping zones in the example of five zones 210a-210e. In this example, overlapping regions 212a-212k are formed in the overlapping area between two adjacent zones 210a-210e, respectively.

Overlapping regions 212a and 212b correspond to the region in which zone 210a overlaps zone 210b and vice versa. Accordingly, the fire fighting area 220 in case a fire F is detected in either region 212a or region 212b will be comprised of both zone 210a and 210b. Likewise, in overlapping regions 212c and 212d zones 210a and 210c will form the fire fighting area 220. A fire F in overlapping region 212e or 212f will yield a fire fighting area 220 with zones 210c and 210d, while a fire F in overlapping region 212g or 212h will result in fire fighting area 220 being formed of zones 210b and 210d.

Finally, in case a fire is present in the outer region of zone 210e, i.e. the region near the edge of zone 210e, which are indicated with 212i, 212j, 212k or 212l, the fire fighting area 220 is formed of zone 210e and one of zones 210a-210d, respectively. Thus, also in this example with overlapping regions, it can be ensured that not more than two zones will be comprised in the fire fighting area 220 at the same time.

FIG. 12 illustrates a perspective view of an embodiment of a fire locator device 7 with a different shape of housing 2. The three sensor components 5a, 5b, 5c are provided in circular indentations of housing 2 and protrude therefrom with a substantially hemispherical form. Each of the respective casing or housing of the sensor components 5a, 5b, 5c comprises a conical well, wherein at the bottom of each well the array sensor 50 is located. The opening angle of the corresponding conical well corresponds to the field of view of the array sensor 50. In this embodiment, the fire fighting devices 3a-3e are external from the fire locator device 7 and not illustrated.

FIG. 13 illustrates perspective views 1400, 1410 of room 101 as an example of the area of operation. In view 1400, the exemplary quadratic layout of room 101 including floor 106 and side walls 103 can be seen. In view 1410, the field of view of a fire locator device 7 having three sensor components, for instance fire locator device 7 of FIG. 12, is illustrated. A field of view 1420, a field of view 1430 and a field of view 1440 corresponds to one respective of sensor components 5a, 5b, and 5c.

It can be seen that the entire surface of the room 101 is imaged by at least one of the sensor components 5a, 5b, 5c, i.e. the fields of view 1420, 1430, 1440 completely fill the area of the room 101. In central areas 1450, the fields of view of different sensor components partially overlap.

FIG. 14 schematically illustrates room 101, in which the five zones 210a-210e and overlapping regions 212a-212k as illustrated in FIG. 11 are illustrated in a perspective view 1500.

FIG. 15 illustrates an overlay of FIG. 14 with the imaging areas of the sensor components, wherein a projection of the pixel grid 17 of the sensor elements of sensor component 5b is provided as an overlay over zones 210-210e. Only the pixel grid 17 of sensor component 5b is illustrated, wherein the mapping between zones 210a-210e and sensor elements of the respective sensor component is likewise determined for sensor component 5a and 5c.

Sensor elements corresponding to a region 1601 will not be mapped to any of zones 210a-210e, since they image an area outside the area of observation. Sensor elements corresponding to a region 1602 will be mapped to zone 210a, region 1603 will be mapped to zone 210c and the further sensor elements corresponding to a region 1604 will be mapped to one or more of zones 210b, 210d and 210e.

### LIST OF REFERENCE SIGNS

1 system
2 housing
   2a,b,c side surface
   2d top surface
   2e bottom surface
   2f mounting extension
   2g rear surface
3a,b,c,d,e fire fighting device
   32 valve
4 fire fighting agent valve
5a,b,c sensor component
   50 array sensor
   52 heating element
   54 interface
6 fire detection device
7 fire locator device
   72 status indicator
   74 maintenance indicator
   76 acoustical indicator
   78 power supply
8 thermistor
9 controller
   90 watchdog timer
   92 mainboard
   93 memory
   94 interface
   95 power interface
   96 serial interface (USB)
   98 maintenance button
11a,b zone
13 projection of pixel grid
15 array
17 pixel grid
100 building
101 room
103 side wall
105 ceiling
106 floor
107 heat source
109 stationary hot spot
210a-e zone
212a-1 overlapping region
220 fire fighting area
310a-h zone
1400, 1410 perspective views of the room
1420, 1430, 1440 field of view of sensor component
1450 central area
1500 perspective view
1601, 1602, 1603,
1604 region of pixel grid
m, n grid parameters
F fire
NF fire-unrelated heat source or non-hazardous fire
T₁, T₂ threshold
α₁, α₂, α₃ angle, field of view

1. A fire locator device comprising:
at least one housing configured to be mounted at a certain height within or in proximity of an area of operation at a wall or a ceiling of a room of a building,
at least one sensor component, wherein each sensor component of the at least one sensor component comprises a plurality of sensor elements in a matrix arrangement sensitive at least to ultraviolet radiation or thermal radiation, or infrared radiation,
a self-test component for validating the operability of the at least one sensor component, and
a controller configured to validate the operability of the at least one sensor component using the self-test component and to receive sensor signals from the at least one sensor component for determining a location of a fire within the area of operation.

2. The fire locator device according to claim 1, wherein the self-test component comprises at least one thermal radiation source, the thermal radiation source being arranged in proximity to at least one of the sensor elements, wherein the controller is configured to validate the operability of at least one of the plurality of the sensor elements by evaluating a sensor signal response to a radiation from the at least one thermal radiation source.

3. The fire locator device according to claim 2, wherein the at least one thermal radiation source is located outside a field of view of the at least one sensor component and configured to temporarily heat the at least one sensor component, such that, in case the at least one sensor component is operable, the sensor signal response of the at least one of the plurality of the sensor elements to a temporal heating of the at least one thermal radiation source is detectable.

4. The fire locator device according to claim 1, wherein the controller is configured to effectuate a self-test of the at least one sensor component using the self-test component on a recurrent, periodic or daily basis.

5. The fire locator device according to claim 1, wherein the controller is configured to sequentially compare sensor signals from the plurality of sensor elements with a threshold value for determining a location of a fire within the area of operation, wherein the threshold value includes an individual threshold value for each of the plurality of sensor elements, respectively.

6. The fire locator device according to claim 1,
wherein the controller is configured to adjust the sensor signal of at least one sensor element by providing a threshold value for the signal value of the corresponding sensor element which exceeds the signal value due to hot objects in the area of operation in case no-hazardous fire is present, and/or
wherein the controller is configured to mask the sensor signal of at least one sensor element including blocking and/or ignoring the value for the signal value of the corresponding sensor element which exceeds the signal value due to hot objects in the area of operation in case no-hazardous fire is present, and/or
wherein the controller is configured to determine malfunctions leading to a stop in operation including dead locks in the operability of the controller itself, using a watchdog timer.

7. The fire locator device according to claim 1, further comprising at least one temperature sensor for determining a temperature of the area of operation or a temperature within or in proximity of the at least one housing.

8. The fire locator device according to claim 1, wherein the controller is configured to receive an input signal from an external fire detection device.

9. The fire locator device according to claim 1, wherein the at least one of the sensor components comprises an infrared sensing array forming the sensor elements.

10. A fire fighting system for fighting a fire in an area of operation in a room of a building, comprising:
the fire locator device according to claim 1, and
a plurality of stationary fire fighting devices, each associated with and configured to distribute fire fighting agent within a respective zone of the area of operation, wherein the controller of the fire locator device is configured to:
locate the zone of the area of operation having the fire by identifying those sensor elements of at least one of the sensor components which sense radiation exceeding a predetermined threshold level, and
activate the at least one fire fighting device associated with the located zone.

11. The fire fighting system according to claim 10, wherein the system further comprises an external fire detection device, wherein the controller of the fire locator device is configured to activate the at least one fire fighting device associated with the located zone only in case the fire detection device detects a fire.

12. The fire fighting system according to claim 10, wherein the controller is configured to determine the operability of the sensor elements of the sensor components using the self-test component, and, in case at least one sensor element is determined to be inoperable, to activate the at least one fire fighting device associated with the zone corresponding to the inoperable sensor element in case a temperature signal indicative of a temperature from a temperature sensor exceeds a predefined threshold.

13. A method of operating a fire locator device according to claim 1, the method comprising:
validating an operability of the sensor elements of the sensor components by the self-testing component,
determining a fire detection signal indicative of a fire from a fire detection device,
determining a sensor signal for each sensor element of the sensor components, and
determining an operation mode of at least one fire fighting device in response to the fire detection signal, the operability of the sensor elements and the sensor signals, the method optionally further comprising
determining a temperature within the area of operation from at least one temperature sensor, wherein the operation mode of the fire fighting device is additionally determined in response to the determined temperature.

14. The method according to claim 13, wherein the fire locator device is configured to selectively activate at least one of a plurality of stationary fire fighting devices in a normal activation mode, each of the stationary fire fighting devices associated with and configured to distribute fire fighting agent within a respective zone of the area of operation,
wherein the controller locates the zone of the area of operation having the fire by identifying at least one hot spot formed by at least one sensor signal exceeding a predetermined threshold level, and
wherein a normal activation mode is determined as the operating mode in which the at least one fire fighting device associated with the located zone is activated in case all sensor elements are determined to be operable, at least one sensor signal exceeds a predefined threshold, wherein the predefined threshold is predefined individually for each sensor element, respectively, and the fire detection signal indicates the presence of a fire.

15. The method according to claim 13, wherein a normal operation mode is determined in case the sensor elements are determined to be operable and at least one of the following conditions are fulfilled:
the fire detection signal indicates no fire and/or
no sensor signal exceeds a predefined threshold, wherein the predefined threshold is predefined individually for each sensor element, respectively, and/or
a maintenance warning mode is determined as the operation mode, and/or
at least one of the sensor components or sensor elements is determined to be inoperable and/or a connection error is determined, and/or
the fire detection device or the temperature sensor is determined to be inoperable and/or a connection error is determined, and/or
a malfunction leading to a stop in operation is determined using a watchdog timer, and/or
a first failure valve opening mode is determined as the operation mode in case at least one sensor element is determined to be inoperable, the fire detection signal indicates the presence of a fire and the temperature signal exceeds a predefined threshold, and/or
a second failure valve opening mode is determined as the operation mode in case the fire detection signal indicates no presence of a fire, the temperature signal exceeds a predefined threshold, and at least one of the sensor signals exceeds a predefined threshold, respectively.
